(19) United States
(12) Patent Application Publication
(10) Pub. No.: US 2001/0015820 A1
(43) Pub. Date: Aug. 23, 2001

(54) METHOD AND APPARATUS FOR CONSERVATION OF MEMORY IN A PRINTER THROUGH SELECTIVE COMPRESSION OF A DISPLAY LIST

(75) Inventors: JAMES R. CONRAD, MERIDIAN, ID (US); ALLEN L. FRAZIER, EAGLE, ID (US); JEFF H. PAPKE, MERIDIAN, ID (US); PATRICK W. FULGHUM, BOISE, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD COMPANY

(21) Appl. No.: 09/114,342

(22) Filed: Jul. 13, 1998

(51) Int. Cl. B41J 1/00; G06F 15/00; G06K 1/00; B41F 1/00; B41B 1/00

(52) U.S. Cl. 358/1.15

(57) ABSTRACT

The method of the invention enables a printer to interpret received page description data and to generate a series of corresponding graphics commands that enable graphic objects to be printed. During the interpreting action, memory resources are allocated for storage of the graphics commands, which are then arranged into a display list. The printer's personality maintains a measure of available memory for allocation and, upon sensing a low memory level, causes a compression of the series of graphics commands in the display list to achieve a more efficient use of the available memory assets.

### FIELD OF THE INVENTION

This invention relates to page printers and, more particularly, to a full color page printer which employs selective display list compression to achieve improved memory utilization.

### BACKGROUND OF THE INVENTION

Page printers commonly employ a page rendering procedure (i.e., often called a printer's “personality”) to convert data received from a host processor into a format that is capable of being rendered onto a media sheet by the printer. The host processor generally feeds the print data to the printer in the form of a page description language, such as PCL (printer control language) or PostScript. The page description data is captured by the printer's personality which then converts the data into an intermediate format. Thereafter the intermediate format data is converted to raster pixel data which is directly printable by a print “engine” included in the printer.

The intermediate format data comprises a list of commands, called display commands, that describe objects to be printed. The display commands are segregated by “page strips” which define a series of contiguous lateral bands on a page to be printed and are thereafter configured into a display list. A rasterizer function then retrieves the display commands and converts them into them raster pixel images.

In full color printers, the entire display list is “run” to enable the generation of individual color planes that represent the image. The combination of the color planes, when fed to the print engine and printed on a media sheet, result in a full color image. To conserve memory during the generation of the raster image, the prior art has utilized compression techniques to enable the color plane pixel data to be stored in smaller regions of memory than would otherwise be required.

The prior art includes many teachings regarding the use of display commands, display lists and selective rasterization of display commands. For instance, U.S. Pat. Nos. 5,509,115 and 5,502,804, both to Butterfield et al., describe a printer system which decomposes basic graphics functions into a series of commands suitable for real-time processing. Those commands are in the form of primitives which can be converted to bit mapped images in real time. Memory utilization is reduced by eliminating redundant or overlapping graphics functions.

U.S. Pat. No. 5,706,478 to Dye describes a processor for executing display list commands in either processor or co-processor modes. The Dye system dynamically switches between the two modes. Each display list command conforms to a single format, regardless of whether the processor is operating in the processor mode or co-processor mode, thereby simplifying the command protocol and eliminating the need for multiple types of commands.

U.S. Pat. No. 5,129,049 to Cuzzo et al. describes a page printer which is adapted to selectively pre-rasterize selected page strips if a rasterization time thereof exceeds a threshold. The Cuzzo et al. procedure assures that there will always be rasterized data available for use by a laser print engine during the print process. U.S. Pat. No. 5,479,587 to Campbell et al. describes a page printer that includes an adaptive print data compression procedure to assure efficient memory utilization. If the procedure determines that there is insufficient memory to be allocated for storage of processed print data, a plurality of compression procedures are succeedingly tried.

The first set of compression procedures comprise those which are termed “lossless”, i.e. those which can be decompressed without loss of image data. The last compression procedure that is utilized is a “lossy” procedure which, by definition, upon decompression results in some loss of printer data.

There is a continuing need, especially in full color printers, to conserve memory during the processing of pages and associated page strips. Since many color printers render an entire page before starting the print engine, substantial amounts of memory are required for the storage of the processed image data, prior to printing. In the past, color printers have employed a “commit to buffer” process to render an “oversize” display list into a fully rasterized, four color plane image. The commit to buffer process is generally triggered by a low memory condition that is sensed by the printer's personality and may employ a lossy data compression method to achieve a desired level of data compression. However, because the commit to buffer action may be triggered multiple times during the rendering of a page strip, each commit to buffer cycle requires the decompression of a target page strip; the rendering of some display list objects into that strip; and then a recompression of the page strip so as to make memory available for other actions. Successive compression and decompression cycles, using lossy compression methods, cause a degradation of the page image. Further, the commit to buffer process, when used in conjunction with compressed color plane raster image data, utilizes additional bus cycles and delays the printing process.

Accordingly, it is an object of this invention to provide an improved method and apparatus for utilization of memory in a full color printer.

It is a further object of this invention to provide an improved method and apparatus for control of a full color printer, wherein use of commit to buffer actions are minimized.

It is another object of this invention to provide a method and apparatus for enabling adaptive compression of a printer's display list to achieve improved memory utilization.

### SUMMARY OF THE INVENTION

The method of the invention enables a printer to interpret received page description data and to generate a series of corresponding graphics commands that enable graphic objects to be printed. During the interpreting action, memory resources are allocated for storage of the graphics commands, which are then arranged into a display list. The printer's personality maintains a measure of available memory for allocation and, upon sensing a low memory level, causes a compression of the series of graphics commands in the display list to achieve a more efficient use of the available memory assets.

### BRIEF DESCRIPTION OF THE DRAWINGS

FIG. 1 is a high level block diagram of a printer that embodies the invention.

FIGS. 2A and 2B illustrate high level logic flow diagrams that embody the method of the invention.

### DETAILED DESCRIPTION OF THE INVENTION

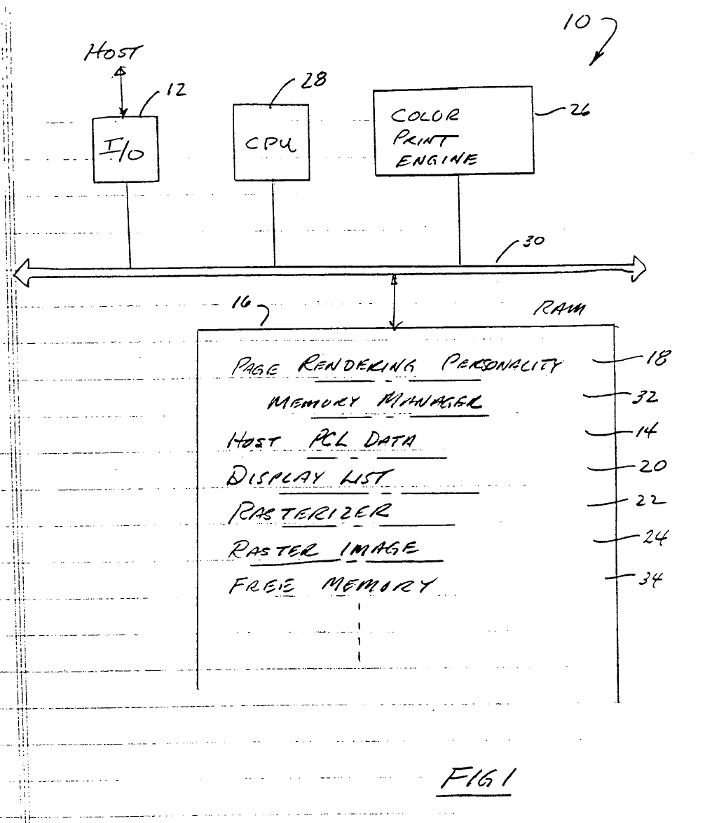

Referring to FIG. 1, a printer 10 is shown that embodies the invention. Printer 10 includes an input/output (I/O) module 12 which receives print data in the form of page description data from a host processor. Hereafter, it will be assumed the host processor provides the print information in the form of PCL data 14 which is temporarily buffered in memory 16. Also stored in random access memory (RAM) 16 are a plurality of procedures and data structures which enable operation of the invention. More particularly, page rendering personality 18 enables conversion of PCL data 14 to an intermediate form, comprising display commands that are listed in a display list 20. For the purpose of explaining the invention, it will be assumed that page rendering pesonality 18 also incorporates a compression procedure for compressing image data. However it is to be understood that such a compression procedure may be an independent procedure or may be incorporated into a hardware module.

A rasterizer procedure 22 in RAM 16 converts the display commands in display list 20 into a raster image 24 which is stored in RAM 16 (in compressed form) prior to being passed to a four color print engine 26. A central processing unit 28 communicates with each of the aforementioned elements via a bus system 30 and is controlled by page rendering personality 18 to perform the invention.

During operation of page rendering personality 18, memory regions within RAM 16 must be allocated to enable storage of various data structures that are created by the operation of page rendering personality 18. Such memory allocation is handled by memory manager 32. Briefly stated, memory manager 32 maintains track of the amount of free memory 34 in RAM 16 that is available for allocation to the various processes that are carried out during the operation of page rendering personality 18. Under certain circumstances, the amount of available free memory 34 may be determined by memory manager 32 to fall below a threshold value. In such case, memory manager 32 manifests a memory low state to page rendering personality 18. In response, page rendering personality 18 attempts to recover additional memory so as to remove the memory low condition.

As will be hereafter explained in detail, page rendering personality 18 first awaits the completion of processing of previously rendered pages to determine if sufficient memory will be released to eliminate the memory low state. If, at such time, the memory low state remains, page rendering personality 18 causes a compression of display commands that are present in display list 20. More particularly, each page strip in display list 20 is organized into data segments “i.e., buckets” and the individual buckets of data are compressed, using a lossless method. Thereafter, additional objects can be placed in a page strip within display list 20 (that already includes compressed buckets), without decompressing the compressed buckets. New buckets are merely chained onto the existing buckets.

If the aforementioned procedure eliminates the memory low state, e.g., by storage of the compressed display list in lieu of the uncompressed display list, page rendering personality 18 can avoid a commit to buffer operation cycle and the processing costs that are inherent therein. The procedure further enables rasterizer 22 to visit each page strip in display list 20 once and only once, thereby increasing the efficiency of processing of the respective page.

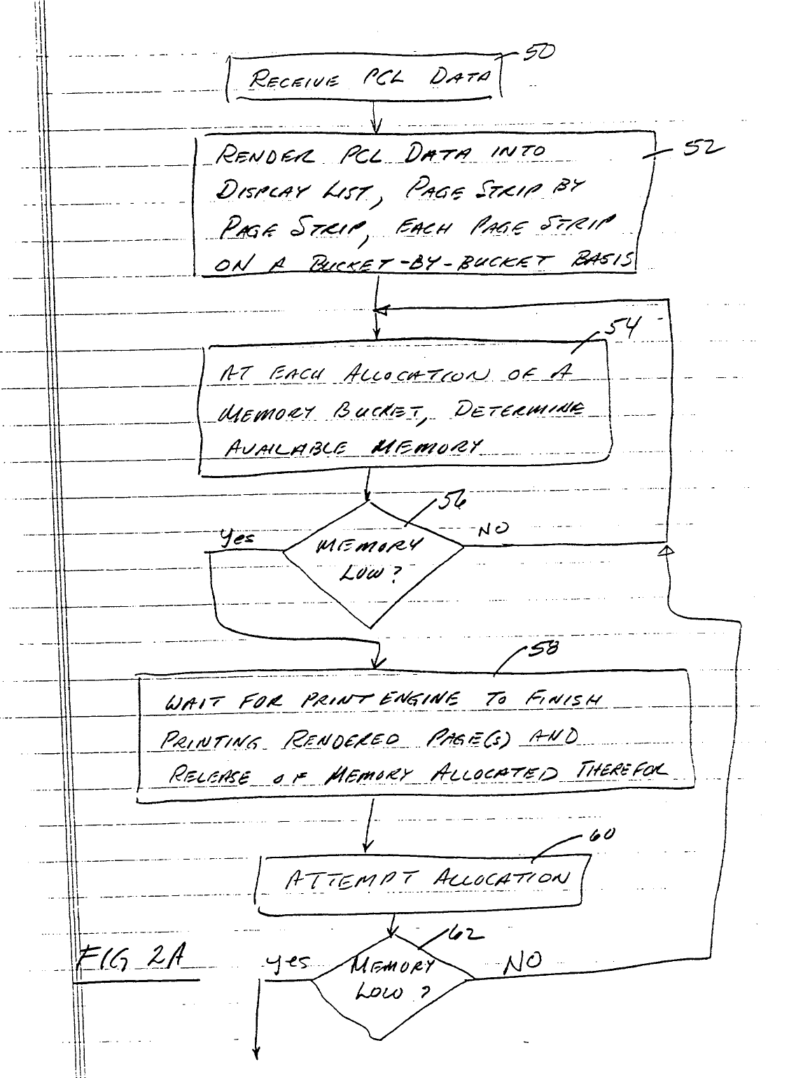

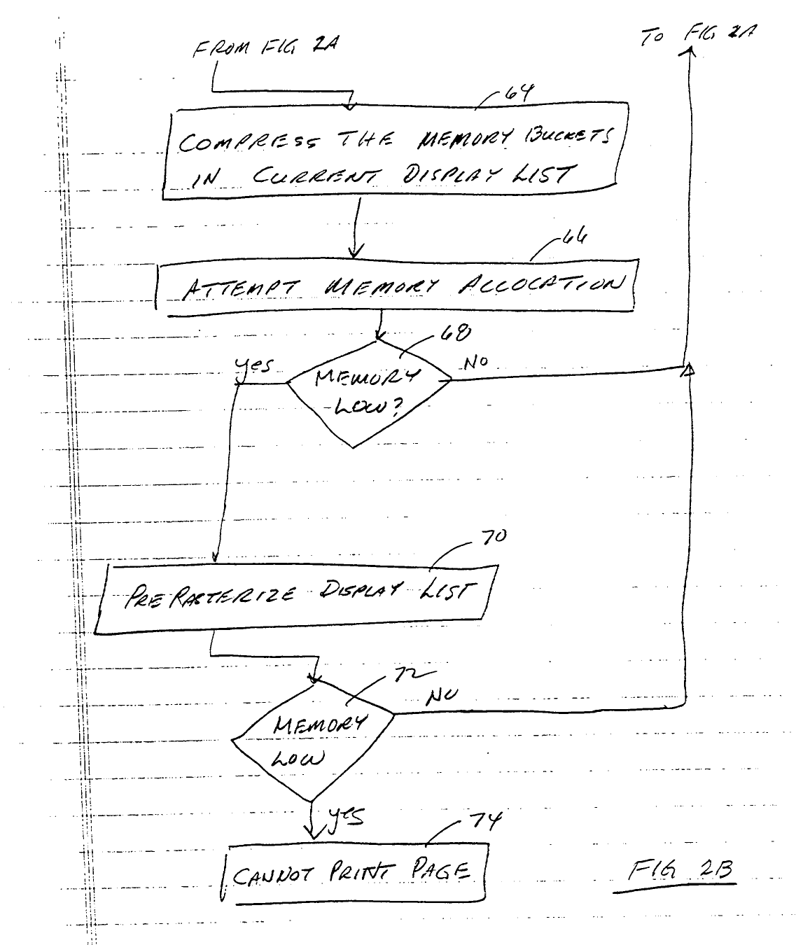

Turning to FIGS. 2A and 2B, the method of the invention will be described. Initially, as described above, it is assumed that I/O module 12 receives PCL image data from a host processor (step 50). Thereafter, page rendering personality 18 renders the PCL data into display commands which are listed on display list 20, on a page strip by page strip basis. Further, the display commands in each page strip are segmented into buckets (or predetermined blocks of memory) so that they can be handled on an individual basis during compression/decompression actions (step 52).

Thereafter, memory manager 32, during each allocation of one or more memory buckets for an object (or objects), determines the amount of available free memory 34 (step 54). If a memory low state is not manifest (decision step 56), the procedure recycles as shown. If, by contrast, a memory low state is manifest, page rendering personality 18 delays further conversion of PCL data into display list commands until print engine 26 has finished printing previously rendered pages and has enabled release of memory allocated therefor (step 58). At such time, memory manager 32 again attempts to allocate one or more memory buckets for the object (objects) being processed (step 60). If the memory low state is no longer manifest (decision step 62), the process recycles back to step 54. If a memory low state is still manifest, page rendering personality 18 compresses the current display list 20 (step 64). More specifically, page rendering personality 18 executes a lossless compression procedure which compresses the data in the buckets that currently form portions of display list 20.

Next, memory manager 32 attempts an allocation of memory for a next procedure to be executed (step 66). Such a procedure may comprise the processing of further PCL data into display commands. Such processing requires that allocation of further buckets be made to store the display commands which, in turn, extends the length of display list 20. Note that by segregating display list 20 into buckets and compressing the individual buckets, there is no need for decompression of already compressed display list data to enable addition of further display list commands that are next to be processed.

If the memory allocation attempted by memory manager 32 finds that the compression of display list 20 has removed the memory low state, the procedure again recycles back to step 54 (decision step 68). Otherwise, page rendering personality 18 is forced to execute a commit to buffer procedure, i.e., a prerasterization of display list 20 (step 70). If the rasterization of the display list does not enable recovery of sufficient memory to remove the memory low state (decision step 72), then it is decided that printer 10 is unable to print the page (step 74). By contrast, if the memory low state is removed, the procedure again recycles and continues.

It should be understood that the foregoing description is only illustrative of the invention. Various alternatives and modifications can be devised by those skilled in the art without departing from the invention. For instance, while a number of procedures (i.e., programs) are indicated as stored in RAM 16, they can also be stored in a Read Only Memory and transferred to RAM 16, as needed. Accordingly, the present invention is intended to embrace all such alternatives, modifications and variances which fall within the scope of the appended claims.

I claim:

1. A printer comprising:
page rendering means for interpreting data in a page description language and, in response, generating a series of graphics commands that define objects to be printed, said series of graphics commands arranged into a display list;
memory manager means for allocating memory resources to store said series of graphics commands, said memory manager means incorporating a measure of available memory for allocation and responsive to a determined low memory indication for causing said page rendering means to compress said series of graphics commands arranged in said display list.

2. The printer as recited in claim 1, wherein said memory manager means arranges said series of graphics commands into predetermined size data blocks and wherein said page rendering means compresses said data blocks that include said graphics commands, upon said low memory indication.

3. The printer as recited in claim 2, wherein said memory manager means continues arranging said series of graphic commands into predetermined size data blocks after said page rendering means has compressed said data blocks, without requiring decompression of already compressed data blocks

4. The printer as recited in claim 1 wherein said memory manager means causes said page rendering means to compress said series of graphics commands arranged into said display list only after waiting for previously rendered pages to be printed and for said memory manager means to release memory previously allocated thereto, and then only if the released memory is sufficient to remove the low memory indication.

5. The printer as recited in claim 4, further comprising:
a rasterizer for converting said series of graphics commands into raster-formatted pixel data; and
wherein, if compression of said display list does not remove said low memory indication, said page rendering means operates said rasterizer to convert said series of graphics commands from said display list into raster-formatted pixel data before continuing with further building of remaining portions of said display list.

6. A method for controlling a printer, said method comprising the steps of:
a) interpreting data in a received page description language and, in response, generating a series of graphics commands that define objects to be printed;
b) allocating memory resources for storage of said graphics commands;
c) arranging said series of graphics commands into a display list;
d) maintaining a measure of available memory for allocation; and
e) responding to a low memory indication derived from said measure of available memory, by causing compression of said series of graphics commands arranged into said display list.

7. The method as recited in claim 6, wherein step c) arranges said series of graphic commands into predetermined size data blocks, and step e) causes said data blocks to be compressed upon said low memory indication.

8. The method as recited in claim 7, step c) continues arranging said series of graphic commands into predetermined size data blocks after said data blocks have been compressed, without requiring decompression of already compressed data blocks

9. The method as recited in claim 6 wherein step e) causes compression of said series of graphics commands arranged into said display list only after waiting for previously rendered pages to be printed and for memory previously allocated thereto to be released, and then only if the released memory is sufficient to remove the low memory indication.

10. The method as recited in claim 9, wherein if compression of said display list by step e) does not remove said low memory indication, step e) converts said series of graphics commands from said display list into raster-formatted pixel data before steps a)-c) continue with further building of remaining portions of said display list.
